(19) United States
(12) Patent Application Publication
(10) Pub. No.: US 2009/0327139 A1
(43) Pub. Date: Dec. 31, 2009

(54) Loosely coupled hosted application system

(75) Inventors: Nirav Yogesh Shah, Seattle, WA (US); Michael James Ott, Redmond, WA (US); Manisha Balasaheb Powar, Redmond, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/147,623

(22) Filed: Jun. 27, 2008

(51) Int. Cl. H04L 9/00

(52) U.S. Cl. 705/71

(57) ABSTRACT

Technologies are described herein for loosely coupling a hosted application system with other computing systems that provide related functionality. A hosted application system is provided in one embodiment that is loosely coupled to a marketing system, a sign-up system, a billing system, and a support system. The loose coupling of the systems allows the hosted application system to be easily configured to restrict the software to which a particular customer can subscribe based upon the capacity of the hosted application system, the qualifications of a customer, or other factors. The computing systems may be configured to communicate via idempotent network APIs, thereby permitting multiple retries to ensure successful completion of requests.

### BACKGROUND

A hosted application is a software application where the software resides on servers that are accessed through a wide-area network (“WAN”), such as the Internet, rather than more traditional software that is installed on a local server or on individual client computers. Hosted applications may also be known as Internet-applications, application service providers (“ASPs”), web-based applications, on-line services, or on-line applications. Hosted applications may be provided on a paid subscription basis for concurrent use by users associated with multiple organizations, called “tenants.”

Many hosted applications are strongly coupled to subsystems that provide related functionality. For instance, the computing systems that provide the actual hosted application may be strongly connected to subsystems that provide billing or other support functions. These strong ties between the hosted application and the related subsystems can limit the flexibility with which the hosted application can be provided. For instance, due to these strong ties, it may be difficult or impossible to restrict the software to which a particular customer can subscribe based upon the capacity of the hosted application or the qualifications of the customer. Similarly, it may be difficult to update the capabilities of any of the related subsystems without affecting the operation of the hosted application itself.

It is with respect to these considerations and others that the disclosure made herein is presented.

### SUMMARY

Technologies are described herein for loosely coupling a hosted application system with other computing systems that provide related functionality. Through the use of the concepts and technologies presented herein, a hosted application system is loosely coupled with related computing systems, such as systems that provide marketing, sign-up, billing, and support functionality. Because the computing systems are loosely coupled, the hosted application system can be easily configured to restrict the software to which a particular customer can subscribe based upon the capacity of the hosted application, the qualifications of a customer, or other factors. Moreover, the loose coupling of the systems allows uninterrupted use of the hosted application system even when a related system is upgraded or impaired.

According to one aspect presented herein, a hosted application system is provided that is loosely coupled to a marketing system, a sign-up system, and a billing system. The hosted application system is configured to provide a hosted application, such as a customer relationship management (“CRM”) application, that is provided on a paid subscription basis. The marketing system provides functionality for marketing the hosted application system to potential customers. The sign-up system provides functionality for signing up customers to the hosted application system. The billing system provides functionality for billing customers of the hosted application system.

According to one aspect, the hosted application system is configured to generate an encrypted product key. The encrypted product key includes a stock-keeping unit (SKU) number, an expiration date, and a unique identifier. The SKU corresponds to one or more offers that are available to the potential customer. An offer is a configuration of services provided by the hosted application system that is available for purchase. The hosted application system provides the encrypted product key to the marketing system that, in turn, provides the encrypted product key to a potential customer of the hosted application system. The marketing system may alternately provide the encrypted product key directly to the sign-up system on behalf of the potential customer.

The potential customer of the hosted application system provides the encrypted product key to the sign-up system at the time of sign-up. The sign-up system, in turn, provides the encrypted product key to the hosted application system for decryption. The hosted application system decrypts the encrypted key to retrieve the SKU, expiration date, and unique identifier contained therein. The hosted application system then determines, based upon the expiration date and the unique identifier, whether the offer corresponding to the SKU should be offered to the potential customer.

If the offer should be made available to the potential customer, the hosted application system returns the SKU to the sign-up system. In turn, the sign-up system makes the offers corresponding to the SKU available to the potential customer. For instance, the sign-up system may display the available offers to the potential customer and permit the potential customer to select one of the offers for purchase. If the potential customer chooses to purchase one of the offers, the sign-up system receives sign-up information from the potential customer, such as contact information. The hosted application system may be consulted to validate the sign-up information provided by the potential customer.

Once the sign-up information has been received, the sign-up system provides this information to the billing system. The billing system then validates the sign-up information to ensure that an identified payment instrument is valid. The billing system then bills the potential customer, if the offer is not a free offer, and returns authorization to the sign-up system to provision service for the new customer at the hosted application system. In response to receiving the authorization, the sign-up system sends a request to the hosted application system to provision service for the new customer. The sign-up system may also send requests to other computing systems to provision other applications or services for the new customer. For instance, the sign-up system may send a request to provision service for the new customer to a support system that provides support for the hosted application system.

According to other aspects, the hosted application system, marketing system, sign-up system, billing system, and support system are configured to communicate through the use of idempotent network application programming interfaces (“APIs”). The idempotent APIs maintain state information regarding received calls. Through the use of the state information, duplicate calls are handled in an identical way. Because the APIs are idempotent, each of the loosely coupled systems presented herein may make multiple calls to an API to ensure its successful completion.

It should be appreciated that the above-described subject matter may also be implemented as a computer-controlled apparatus, a computer process, a computing system, or as an article of manufacture such as a computer-readable medium. These and various other features will be apparent from a reading of the following Detailed Description and a review of the associated drawings.

This Summary is provided to introduce a selection of concepts in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a network diagram showing aspects of an illustrative operating environment and several computing systems provided by the embodiments presented herein;

FIG. 2 is a data structure diagram showing aspects of a product key utilized in embodiments presented herein;

FIGS. 3-5 are system architecture diagrams showing aspects of the operation of several computing systems provided in embodiments disclosed herein;

FIGS. 6A-6C are flow diagrams showing aspects of one process provided herein for loosely coupling a hosted application system with other computing systems in one embodiment; and

FIG. 7 is a computer architecture diagram showing an illustrative computer hardware and software architecture for a computing system capable of implementing aspects of the embodiments presented herein.

### DETAILED DESCRIPTION

The following detailed description is directed to technologies for loosely coupling a hosted application system with other computing systems that provide related functionality. While the subject matter described herein is presented in the general context of program modules that execute in conjunction with the execution of an operating system and application programs on a computer system, those skilled in the art will recognize that other implementations may be performed in combination with other types of program modules. Generally, program modules include routines, programs, components, data structures, and other types of structures that perform particular tasks or implement particular abstract data types. Moreover, those skilled in the art will appreciate that the subject matter described herein may be practiced with other computer system configurations, including hand-held devices, multiprocessor systems, microprocessor-based or programmable consumer electronics, minicomputers, mainframe computers, and the like.

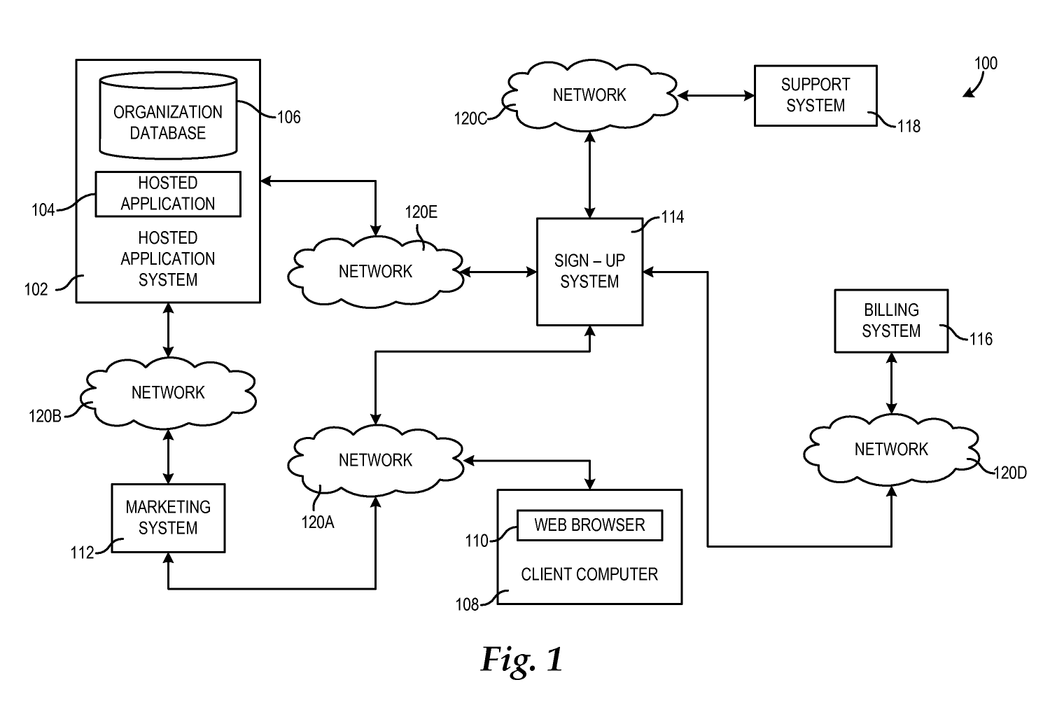

In the following detailed description, references are made to the accompanying drawings that form a part hereof, and which are shown by way of illustration specific embodiments or examples. Referring now to the drawings, in which like numerals represent like elements through the several figures, aspects of a computing system 100 and methodology for a loosely coupled hosted application system will be described. In particular, FIG. 1 is a network and software architecture diagram that provides details regarding an illustrative operating environment for the embodiments presented herein along with aspects of several software components presented herein. As discussed briefly above, a hosted application system 102 is provided in one embodiment that is configured to provide a hosted, multi-tenant application program.

In the embodiments presented herein, the application program is a program for providing CRM functionality. CRM applications allow businesses to manage the relationships with their customers, including the capture, storage, and analysis of customer information. It should be appreciated, however, that any type of hosted application may be implemented utilizing the technologies presented herein, including other types of hosted business applications.

Through the use of the hosted application system 102, multiple organizations, referred to herein as “tenants,” may concurrently utilize the computing resources provided by the hosted application system 102. In this regard, the hosted application system 102 executes the hosted application 104 and maintains one or more associated databases, such as the organization database 106.

The functionality provided by the hosted application system 102 may be accessed through the use of a World Wide Web (“web”) browser application 110 executing on a client computer, such as the client computer 108. In this regard, the hosted application 104 includes a web user interface (“UI”) module for exposing a web-compatible network interface. In this manner, the client computer 108 can be utilized to access functionality provided by the hosted application 104. It should be appreciated that other types of programs may also be utilized to access the functionality provided by the hosted application 104. For instance, a personal information manager (“PIM”) or e-mail client may be configured for use with the hosted application 104. Other types of client application programs may also be similar configured to operate with the interfaces exposed by the hosted application 104.

As shown in FIG. 1, the hosted application system 102 operates in conjunction with a marketing system 112. The marketing system 112 provides functionality for marketing the hosted application system 102 to potential customers. For instance, in one implementation, the marketing system 112 may provide a web UI accessible through the web browser 110 that provides marketing information for the hosted application system 102. Through the web UI, a potential customer of the hosted application system 102 may discover information regarding the features, functionality, and benefits of the service provided by the hosted application system 102. A potential customer may also retrieve information regarding various offers available for purchase. Each offer represents a configuration of services provided by the hosted application system 102 that is made available to a potential customer. For instance, one offer may provide a limited set of functionality while another offer provides a more expansive set of functionality.

According to implementations, the marketing system 112 is configured to restrict offers to potential customers based on one or more predetermined factors. For instance, the marketing system 112 may prequalify potential customers and provide certain offers only to potential customers that meet certain predefined demographic requirements. As an example, the marketing system 112 may ask a potential customer how many employees are within their organization and restrict the type of offers that are available to the potential customers based upon the response. Organizations with a small number of employees may be offered a limited set of functionality while organizations with a larger number of employees may be offered a more expansive set of functionality. As another example, the price for a subscription to the hosted application system 102 may be similarly modified based upon such demographic information. Additional details regarding the processes utilized by the hosted application system 102 and the marketing system 112 to present offers to potential customers will be described in greater detail below.

As illustrated in FIG. 1, the hosted application system 102 also operates in conjunction with a sign-up system 114. The sign-up system 114 provides functionality for signing up customers to the hosted application system 102. In particular, in one implementation, the sign-up system 114 provides a web UI through which a potential customer can provide sign-up information. Sign-up information may include contact information for the potential customer, billing information, and other details. As will be discussed in greater detail below, the sign-up system 114 operates in conjunction with the marketing system 112 and the hosted application system 102 to present available offers to a potential customer, receive the billing information from the potential customer, and to cause the hosted application system 102 to provision service for the potential customer. Additional details regarding these processes will be provided in greater detail below.

As illustrated in FIG. 1, the hosted application system 102 also operates in conjunction with a billing system 116. The billing system 116 provides functionality for billing a customer of the hosted application system 102. For instance, the billing system 116 may charge a credit card or other form of payment on behalf of the hosted application system 102 for the provision of service to a customer.

As will also be described in greater detail below, the sign-up system 114 transmits sign-up information received from a potential customer to the billing system 116. If the billing system 116 can validate the sign-up information and charge the customer for the provision of service, an authorization is returned to the sign-up system 114 to provision service for the new customer. In turn, the sign-up system 114 transmits a request to the hosted application system 102 to provision service for the new customer.

In other embodiments, the sign-up system 114 may also transmit a request to provision other types of applications or services for the new customer. For example, the sign-up system 114 may transmit a request to a support system 118 to provision support functionality for the new customer. In this regard, the support system 118 is configured to provide support to users of the hosted application system 102. It should be appreciated that the sign-up system 114 may request any number of additional systems to provision applications or services for a new customer of the hosted application system 102. Similarly, the sign-up system 114 may request a provision of service at the hosted application system 102 in response to service being provisioned at another system not illustrated in FIG. 1. Additional details regarding the operation of the sign-up system 114 and the billing system 116 will be provided in greater detail below.

As illustrated in FIG. 1, the hosted application system 102, marketing system 112, sign-up system 114, client computer 108, support system 118, and billing system 116 are configured to communicate via one or more data communications networks, such as the networks 120A-120E. It should be appreciated however that the networks illustrated in FIG. 1 are merely illustrative and that more or fewer networks than those illustrated in FIG. 1 may be utilized.

It should also be appreciated that the depiction of the various systems in FIG. 1 has been simplified and that each of the systems illustrated therein may comprise any number of processing and storage systems. For instance, the hosted application system 102 may comprise any number of computers configured for executing the hosted application 104 and for providing data storage capabilities to the hosted application 104. Moreover, the various computing systems within the hosted application system 102 may be geographically dispersed and configured for communication utilizing virtually any network topology. The other systems illustrated in FIG. 1 may also be similarly configured.

According to one implementation, the hosted application system 102, marketing system 112, sign-up system 114, billing system 116, and support system 118 are configured to communicate via one or more idempotent network APIs. As mentioned briefly above, these idempotent APIs maintain state information regarding calls received from other systems. Through the use of this state information, subsequent but duplicate calls may be handled in an identical way to the original call. In this way, a duplicate call to an API will result in the same result as the original call. Because idempotent APIs are utilized by the systems illustrated in FIG. 1, each of the systems can retry the requests described herein multiple times to ensure that the requests are successfully completed. Moreover, any of the systems illustrated in FIG. 1 may retry API calls to any other system to ensure that the requested operations are performed. In this manner, the various systems shown in FIG. 1 can operate without knowledge of the internal operation of the other systems and the success or failure of each system will not impact the operation of the other systems.

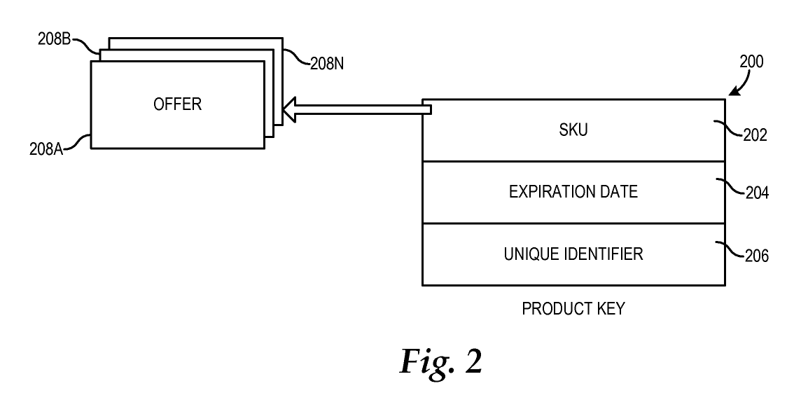

Referring now to FIG. 2, details regarding a product key 200 utilized in the embodiments presented herein will be disclosed. As will be described in greater below, the hosted application system 102 is configured in one embodiment to generate an encrypted product key 200 and to provide the encrypted product key 200 to the marketing system 112. In turn, the marketing system 112 may provide the encrypted product key 200 to a potential client or directly to the sign-up system 114 on behalf of the potential customer.

The encrypted product key 200 includes information that identifies one or more offers 208A-208N that the potential customer is eligible to purchase. For instance, the offers 208A-208N may correspond to a free trial of the hosted application system 102 that would generally not be available to the customer without the use of the encrypted product key 200. When an encrypted product key 200 is provided to the sign-up system 114, the sign-up system 114 will provide the encrypted product key 200 to the hosted application system 102. The hosted application system 102 will decrypt the encrypted product key 200 and return to the sign-up system 114 data identifying the offers 208A-208N that the encrypted product key 200 can be utilized to purchase. In this manner, the hosted application system 102 can restrict certain sets of offers from the potential customer while still isolating the other systems involved in the sign-up experience. It should be appreciated that the sign-up system 114 is not capable of decrypting the encrypted product keys issued by the hosted application system 102.

According to one embodiment, the encrypted product key 200 includes a SKU 202, an expiration date 204, and a unique identifier 206. The SKU 202 corresponds to the offers 208A-2208N that the potential customer is entitled to purchase. The expiration date 204 corresponds to a date after which the product key 200 is no longer valid. The unique identifier 206 uniquely identifies the product key 200. As will be discussed in greater detail below, the unique identifier 206 may be utilized by the hosted application system 102 to limit the number of times that any product key 200 may be utilized. It should be appreciated that additional data not shown in FIG. 2 may also be included in the encrypted product key 200.

According to embodiments, the implementation of the product key 200 presented herein allows the hosted application system 102 to throttle the number of subscriptions in a variety of ways. For instance, the hosted application system 102 may be configured to invalidate all of the product keys 200 that have been issued so that no one can purchase a new subscription to the hosted application system 102. The manner in which the product keys 200 are invalidated may also be performed in several different ways. One way is to temporarily invalidate the product keys 200 due to capacity limitations of the hosted application system 102 or system down time. Another manner in which the product keys 200 may be invalidated is to invalidate all previously issued product keys 200 permanently such as, for instance, due to a potential security breach of the hosted application system 102. The hosted application system 102 can also throttle the use of product keys 200 based upon the particular SKUs 202 that a potential customer intends to purchase. In this manner, the hosted application system 102 provides flexibility to best utilize the resources currently available to it.

It should be appreciated that in one embodiment the hosted application system 102 does not store the product keys 200. Rather, the hosted application system 102 need only store data sufficient to decrypt the previously encrypted product keys 200. When a product key 200 is decrypted, the unique identifier 206 may be stored by the hosted application system 102 to indicate that the product key has been redeemed and should be invalidated. Additional details regarding the use of the product key 200 by the computer systems illustrated in FIG. 1 will be presented below.

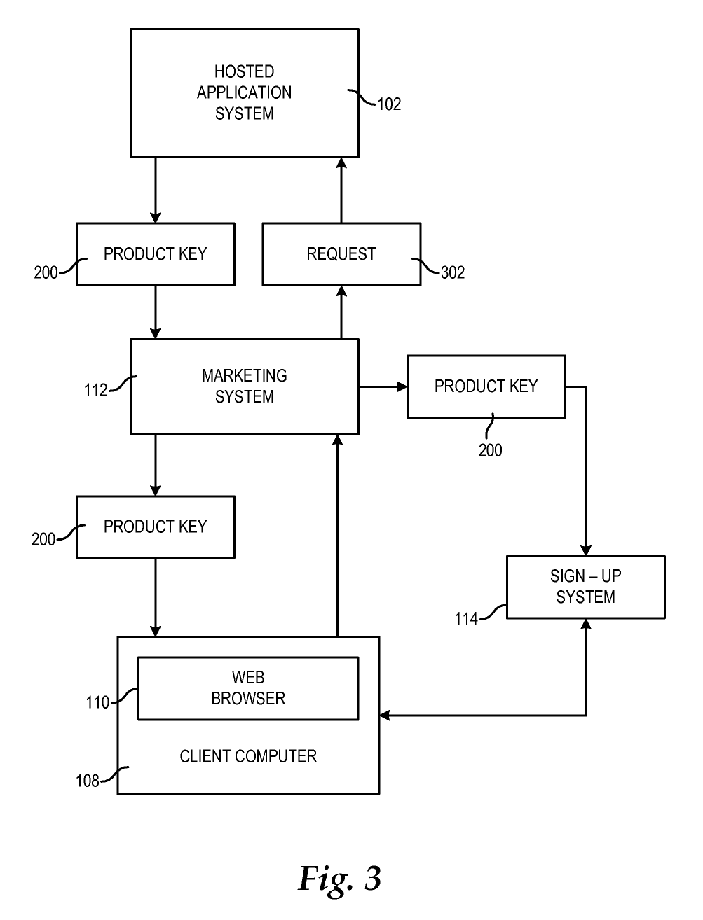

Referring now to FIG. 3, additional details will be provided regarding the generation and use of a product key 200. As described briefly above, the marketing system 112 provides an interface that may be accessed using the web browser 110 executing on the client computer 108 for viewing marketing information regarding the hosted application system 102. As also mentioned above, the marketing system 112 is configured to provide a product key 200 to a potential customer of the hosted application system 102. In order to determine whether a potential customer to the hosted application system 102 should be provided a product key 200, the marketing system 112 may request various data from the potential customer, such as the number of users within the potential customer's organization, type of business, anticipated use of the hosted application system 102, or other information. Based upon this information, the marketing system 112 may determine that a product key 200 should be issued to the potential customer. In response to making such a determination, a request 302 is transmitted from the marketing system 112 to the hosted application system 102 for a product key 200 corresponding to one or more offers 208A-208N that should be made available to the potential customer.

In response to receiving the request 302, the hosted application system 102 generates a product key 200 for the potential customer. As discussed above with reference to FIG. 2, the product key 200 includes an SKU 202 corresponding to the offers 208A-208N, an expiration date 204, and a unique identifier 206. When the marketing system 112 receives the product key 200, it provides the product key 200 to the potential customer. For instance, the marketing system 112 may provide the product key 200 to the web browser 110. Alternatively, the marketing system 112 may provide the product key 200 directly to the sign-up system 114. In either case, the product key 200 is utilized by the potential customer at the sign-up system 114 to sign up for a subscription to the hosted application system 102. Additional details regarding this process will be provided below.

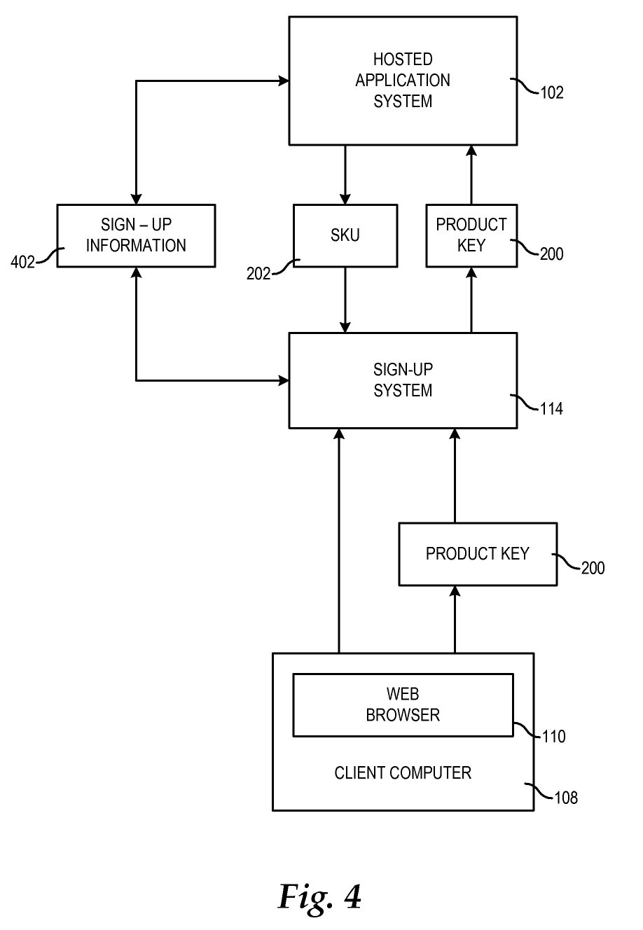

Turning now to FIG. 4, details regarding the functionality provided by the sign-up system 114 in one implementation will be described. As discussed briefly above, the sign-up system 114 provides functionality for permitting a potential customer to sign-up for service from the hosted application system 102. As also discussed briefly above, the marketing system 112 is configured to provide a product key 200 to the client computer 108 or directly to the sign-up system 114 on behalf of a potential customer. In response to receiving a product key 200 for a potential customer, the sign-up system 114 is configured to transmit the product key 200 to the hosted application system 102.

When the hosted application system 102 receives the product key 200, the hosted application system 102 decrypts the product key 200 to retrieve the SKU 202, the expiration date 204, and the unique identifier 206 encrypted therein. The hosted application system 102 then utilizes the extracted expiration date 204 and unique identifier 206 to determine whether the received product key 200 is valid. If the received product key 200 is invalid, an error may be returned to the sign-up system 114 indicating that the product key 200 has expired or has otherwise been invalidated. If, however, the product key 200 is valid, the hosted application system 102 is configured to return data identifying the offers 208A-208N that are available to the potential customer to the sign-up system 114. In this regard, the hosted application system 102 may return the SKU 202 extracted from the encrypted product key to the sign-up system 114 to identify the offers 208A-208N. Once the sign-up system 114 has received the SKU 202, it is configured to display the offers 208A-208N that are available to the potential customer. The potential customer then may indicate that they would like to subscribe to one of the available offers 208A-208N.

In response to receiving a request from a potential customer to subscribe to one of the available offers 208A-208N, the sign-up system 114 is configured to receive sign-up information 402 from the potential customer. The sign-up information 402 is information necessary to sign a new customer up to the hosted application system 102. For instance, the sign-up information 402 may include contact information, billing information such as a credit card number or other payment information, and other data. As will be discussed in greater detail below, the sign-up system 114 provides the sign-up information 402 to the billing system 116.

In one implementation, the sign-up system 114 is configured to verify the sign-up information 402 with the hosted application system 102. For instance, in this implementation, the sign-up system 114 may be configured to transmit the sign-up information 402 to the hosted application system 102 to ensure that duplicate customer names are not created or to cause the hosted application system 102 to reserve a domain name for a new customer. Other types of verification of the sign-up information 402 may be provided by the hosted application system 102. Additional details regarding the sign-up and provision process are described below.

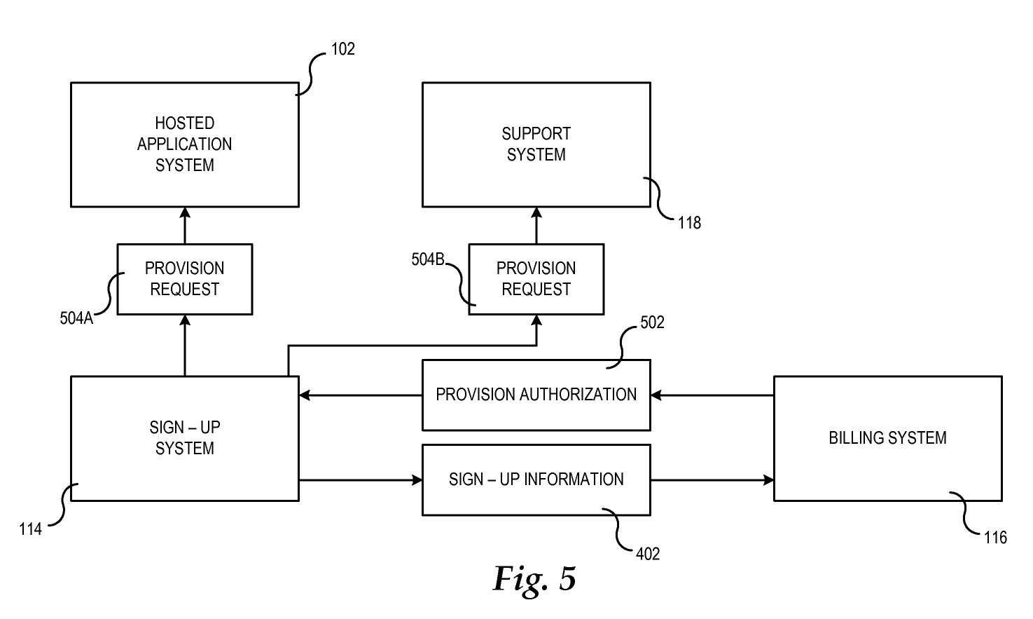

Referring now to FIG. 5, additional details will be provided regarding one process for billing a customer for a subscription to the hosted application system 102 and for provisioning the hosted application system 102. As illustrated in FIG. 5 and described briefly above, the sign-up system 114 transmits the sign-up information 402 to the billing system 116. In response to receiving the sign-up information 402, the billing system 116 makes an attempt to bill the customer for the subscription to the hosted application system 102. For instance, the billing system 116 may attempt to make a charge to a credit card number provided within the sign-up information 402. If the attempt to bill the customer is successful, the billing system 116 returns a provision authorization 502 to the sign-up system 114. The provision authorization 502 indicates to the sign-up system 114 that a bill has been generated for the customer and that provisioning of the hosted application system 102 may take place.

In response to receiving the provision authorization 502, the sign-up system 114 transmits a provision request 504A to the hosted application system 102. In response to receiving the provision request 508A, the hosted application system 102 provisions new service for the new customer. According to embodiments, the sign-up system 114 may also provision other types of applications and services for the new customer in response to receiving the provision authorization 502. For instance, in the embodiment illustrated in FIG. 5, a provision request 504B has been transmitted to the support system 118. In this implementation, the support system 118 is a subsystem that provides support functionality for the hosted application 104. It should be appreciated that any number of such applications or services may be provisioned for a new customer in a similar manner. It should also be appreciated that provisioning of the hosted application system 102 for a new customer may occur in response to a customer subscribing to another service or application.

Based upon the discussion above regarding FIGS. 1-5, it should be appreciated that the loosely coupled nature of the hosted application system 102, the marketing system 112, the sign-up system 114, the billing system 116, and the support system 118 allows the system 100 to not be impacted by changes or modifications made to each of the various systems. Additionally, because the hosted application system 102 is isolated from the other systems, additional features can be added to the marketing system 112, the sign-up system 114, the support system 118, and the billing system 116 without impacting the hosted application system 102 itself. This allows additional systems not illustrated in the figures to be added to the system 100 or to enhance the systems without impacting the provision of the hosted application 104.

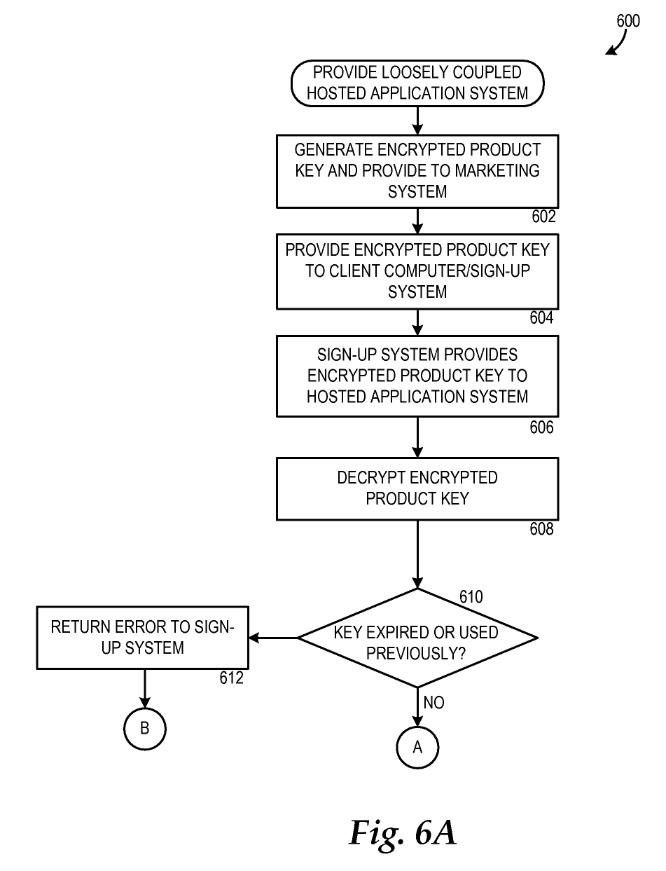

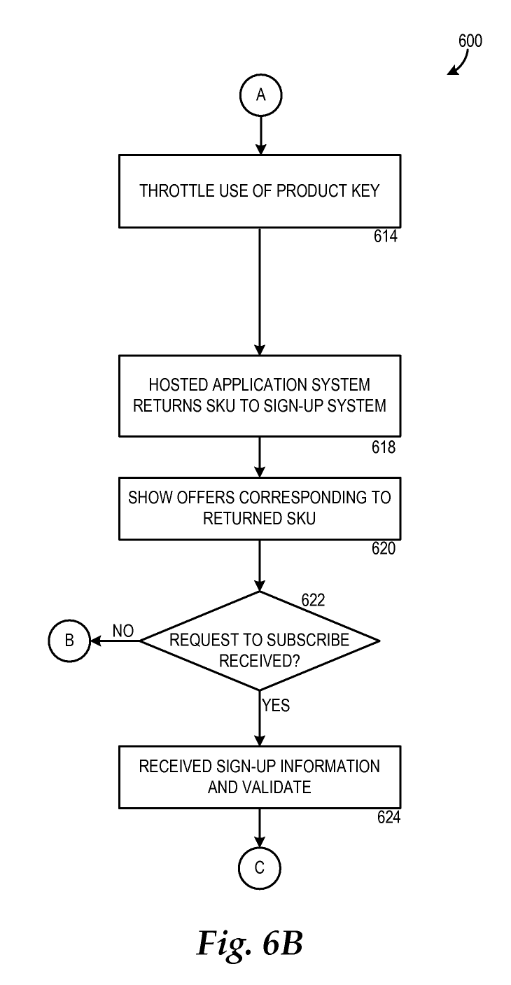

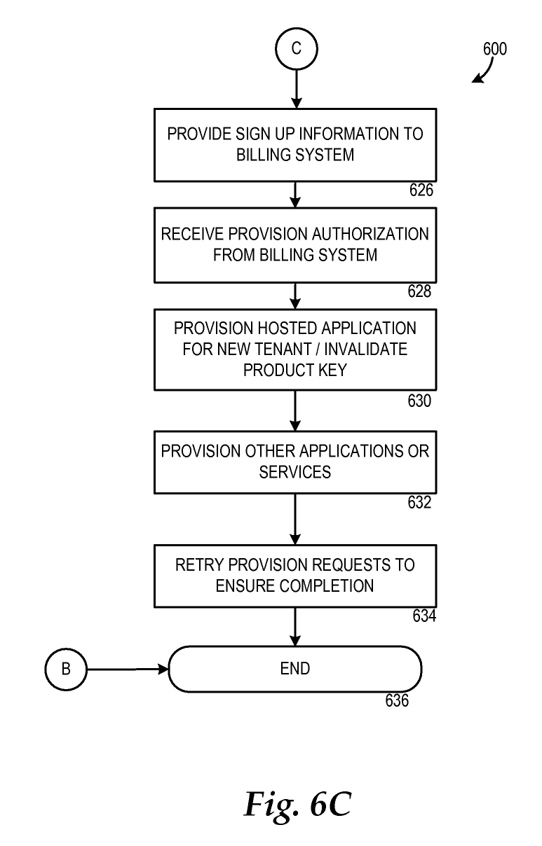

Referring now to FIGS. 6A-6C, additional details will be provided regarding the embodiments presented herein for providing a loosely coupled hosted application system. In particular, FIGS. 6A-6C are flow diagrams illustrating aspects of the operation of the various computing systems herein in one embodiment. It should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states operations, structural devices, acts, or modules. These operations, structural devices, acts and modules may be implemented in software, in firmware, in special purpose digital logic, and any combination thereof. It should also be appreciated that more or fewer operations may be performed than shown in the figures and described herein. These operations may also be performed in a different order than those described herein.

The routine 600 begins at operation 602, where the hosted application system 102 generates the encrypted product key 200 and provides the encrypted product key 200 to the marketing system 112. The routine 600 then proceeds to operation 604, where the marketing system 112 provides the encrypted product key to the client computer 108 or directly to the sign-up system 114 on behalf of a potential customer. When a potential customer visits the sign-up system 114, the sign-up system 114 provides the product key to the hosted application system 102. This occurs at operation 606.

At operation 608, the hosted application system 102 receives the encrypted product key 200 and decrypts the SKU 202, expiration date 204, and unique identifier 206 contained therein. The routine 600 then continues to operation 610 where the hosted application system 102 determines whether the product key 200 has expired or has been used previously. As discussed briefly above, the determination as to whether the product key 200 has been utilized previously may be made based upon the unique identifier 206. The determination as to whether the product key 200 has expired may be made based upon the expiration date 204.

If the hosted application system 102 determines that the product key 200 has expired or been utilized previously, the routine 600 proceeds from operation 610 to operation 612 where the hosted application system 102 returns an error message to the sign-up system 114. If the product key 200 has not expired or been used previously, the routine 600 proceeds from operation 610 to operation 614.

At operation 614, the hosted application system 102 may throttle the use of the product key 200. As discussed above, the hosted application system 102 may be configured in an embodiment to restrict the use of certain product keys based upon the qualifications of the potential customer, the capacity of the hosted application system 102, or other factors.

From operation 614, the routine 600 proceeds to operation 618 where the hosted application system 102 returns the SKU 202 from the encrypted product key 200 to the sign-up system 114. The routine 600 then proceeds to operation 620 where the sign-up system 114 shows the offers available to the potential customer that correspond to the returned SKU 202.

From operation 620, the routine 600 proceeds to operation 622 where the sign-up system 114 determines whether the potential customer has requested to subscribe to one of the offers corresponding to the returned to the SKU 202. If not, the routine 600 proceeds to operation 636, described below. If the potential subscriber requests to subscribe to the hosted application system 102, the routine 600 proceeds from operation 622 to operation 624.

At operation 624, the sign-up system 114 receives the sign-up information 402 from the customer. The routine 600 then proceeds to operation 626, where the sign-up system 114 provides the sign-up information 402 to the billing system 116. As discussed above, the billing system 116 utilizes the sign-up information 402 to bill a new customer for the provision of the hosted application system 102.

If the billing system 116 can successfully bill the new customer, the routine 600 proceeds to operation 628 where the billing system 116 provides the provision authorization 502 to the sign-up system 114. In response to receiving the provision authorization 502, the sign-up system 114 transmits the provision request 504A to the hosted application system 102. In response to receiving the provision request 504A, the hosted application system 102 provisions new service for the customer. This occurs at operation 630 of the routine 600.

At operation 630, the hosted application system 102 may also invalidate the product key 200. In one embodiment, the product key 200 is invalidated by storing the unique identifier 206 at the hosted application system 102. If the product key 200 is received subsequently, the hosted application system 102 will determine if the unique identifier 206 contained therein has been previously stored. If so, the hosted application system 102 may not permit the supplied product key 200 to be utilized. It should be appreciated that other methods for invalidating a product key 200 may be utilized.

From operation 630, the routine 600 proceeds to operation 632 where the sign-up system 114 provisions other applications or services one behalf of the new customer. For instance, as discussed above, the sign-up system 114 is configured in one embodiment to transmit a provision request 504B to the support system 118. As discussed above, any of the operations performed by the hosted application system 102, the marketing system 112, the sign-up system 114, the support system 118, and the billing system 116 may be retried multiple times to ensure completion. Because the APIs utilized by these systems are idempotent, multiple retries of the same request will not adversely affect the system. These retries occur at operation 634. From operation 634, the routine 600 proceeds to operation 636, where it ends.

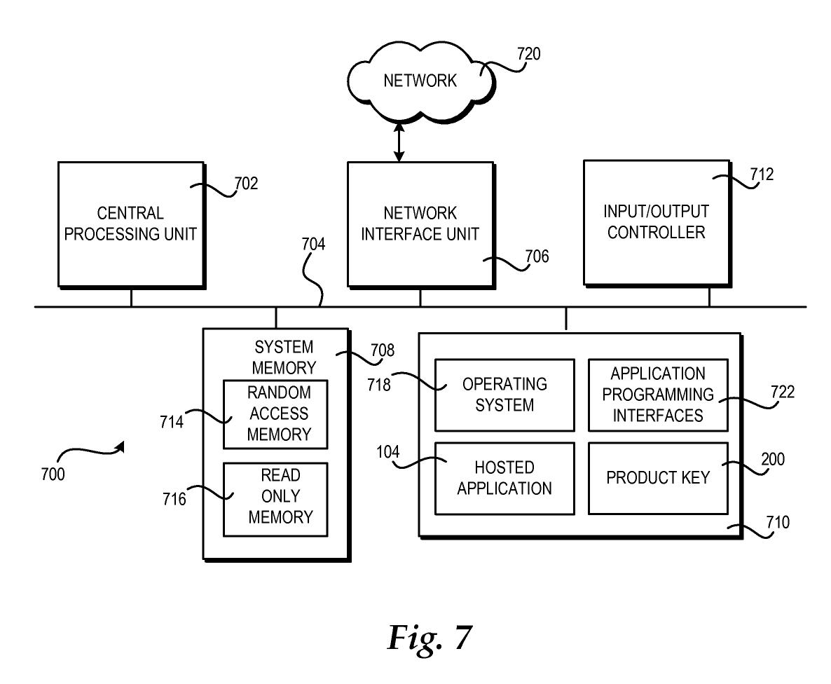

FIG. 7 shows an illustrative computer architecture for a computer 700 capable of executing the software components described herein. The computer architecture shown in FIG. 7 illustrates a conventional desktop, laptop, or server computer and may be utilized to execute any aspects of the software components presented herein described as executing on the hosted application system 102, the marketing system 112, the client computer 108 the sign-up system 114, the support system 118, and the billing system 116.

The computer architecture shown in FIG. 7 includes a central processing unit 702 (“CPU”), a system memory 708, including a random access memory 714 (“RAM”) and a read-only memory (“ROM”) 716, and a system bus 704 that couples the memory to the CPU 702. A basic input/output system containing the basic routines that help to transfer information between elements within the computer 700, such as during startup, is stored in the ROM 716. The computer 700 further includes a mass storage device 710 for storing an operating system 718, application programs, and other program modules, which have been described in greater detail herein.

The mass storage device 710 is connected to the CPU 702 through a mass storage controller (not shown) connected to the bus 704. The mass storage device 710 and its associated computer-readable media provide non-volatile storage for the computer 700. Although the description of computer-readable media contained herein refers to a mass storage device, such as a hard disk or CD-ROM drive, it should be appreciated by those skilled in the art that computer-readable media can be any available computer storage media that can be accessed by the computer 700.

By way of example, and not limitation, computer-readable media may include volatile and non-volatile, removable and non-removable media implemented in any method or technology for storage of information such as computer-readable instructions, data structures, program modules or other data. For example, computer-readable media includes, but is not limited to, RAM, ROM, EPROM, EEPROM, flash memory or other solid state memory technology, CD-ROM, digital versatile disks (“DVD”), HD-DVD, BLU-RAY, or other optical storage, magnetic cassettes, magnetic tape, magnetic disk storage or other magnetic storage devices, or any other medium which can be used to store the desired information and which can be accessed by the computer 700.

According to various embodiments, the computer 700 may operate in a networked environment using logical connections to remote computers through a network such as the network 720. The computer 700 may connect to the network 720 through a network interface unit 706 connected to the bus 704. It should be appreciated that the network interface unit 706 may also be utilized to connect to other types of networks and remote computer systems. The computer 700 may also include an input/output controller 712 for receiving and processing input from a number of other devices, including a keyboard, mouse, or electronic stylus (not shown in FIG. 7). Similarly, an input/output controller may provide output to a display screen, a printer, or other type of output device (also not shown in FIG. 7).

As mentioned briefly above, a number of program modules and data files may be stored in the mass storage device 710 and RAM 714 of the computer 700, including an operating system 718 suitable for controlling the operation of a networked desktop, laptop, or server computer. The mass storage device 710 and RAM 714 may also store one or more program modules. In particular, the mass storage device 710 and the RAM 714 may store the hosted application 104, the product key 200, and the idempotent APIs 722, each of which was described in detail above with respect to FIGS. 1-6C. The mass storage device 710 and the RAM 714 may also store other types of program modules and data files.

Based on the foregoing, it should be appreciated that technologies for providing a loosely coupled hosted application system are provided herein. Although the subject matter presented herein has been described in language specific to computer structural features, methodological acts, and computer readable media, it is to be understood that the invention defined in the appended claims is not necessarily limited to the specific features, acts, or media described herein. Rather, the specific features, acts and mediums are disclosed as example forms of implementing the claims.

The subject matter described above is provided by way of illustration only and should not be construed as limiting. Various modifications and changes may be made to the subject matter described herein without following the example embodiments and applications illustrated and described, and without departing from the true spirit and scope of the present invention, which is set forth in the following claims.

What is claimed is:

1. A system of loosely coupled computing systems, the system comprising:
a first computing system configured to generate an encrypted product key; and
a second computing system configured to receive the encrypted product key and, in response thereto, to submit the encrypted product key to the first system for decryption, to receive a stock-keeping unit (SKU) identifying one or more offers available to a potential customer from the first computing system, and to make the one or more offers available to the potential customer.

2. The system of claim 1, further comprising:
a third computing system configured to request the encrypted product key from the first computing system and to provide the encrypted product key to the potential customer.

3. The system of claim 2, further comprising:
a fourth computing system configured to receive sign-up information from the second computing system, to validate the sign-up information, and to provide an authorization to provision service for the potential customer to the second computing system, and wherein the second computing system is further configured to transmit a request to the first computing system to provision service for the potential customer in response to receiving the authorization.

4. The system of claim 3, wherein the second computing system is further configured to transmit a request to provision service for the potential customer to a fifth computing system.

5. The system of claim 4, wherein the first computing system comprises a hosted application system, the second computing system comprises a sign-up system, the third computing system comprises a marketing system, and the fourth computing system comprises a billing system.

6. The system of claim 5, wherein the hosted application system, sign-up system, marketing system, and billing system are configured to communicate via one or more idempotent application programming interfaces (APIs).

7. The system of claim 6, wherein the encrypted product key comprises the stock-keeping unit (SKU), an expiration date, and a unique identifier.

8. A method for loosely coupling a hosted application system with a marketing system, a sign-up system, and a billing system, the method comprising:
generating an encrypted product key at the hosted application system;
providing the encrypted product key to a potential customer of the hosted application system;
receiving the encrypted product key at the sign-up system; and
in response to receiving the encrypted product key at the sign-up system, providing the encrypted product key to the hosted application system, decrypting the encrypted product key at the hosted application system to extract a stock-keeping unit (SKU) from the encrypted product key, identifying one or more offers available to the potential customer based upon the SKU, and making the one or more offers available to the potential customer at the sign-up system.

9. The method of claim 8, wherein the encrypted product key comprises the stock-keeping unit (SKU), an expiration date, and a unique identifier.

10. The method of claim 9, wherein the SKU corresponds to the one or more offers available to the potential customer.

11. The method of claim 10, further comprising:
receiving at the sign-up system a request to subscribe to one of the offers; and
in response to receiving the request, receiving sign-up information from the potential customer, providing the sign-up information to the billing system, receiving from the billing system an authorization to provision service for the potential customer, and transmitting a request to the hosted application system to provision service for the potential customer.

12. The method of claim 11, further comprising:
providing the sign-up information to the hosted application system;
receiving the sign-up information at the hosted application system; and
verifying the sign-up information at the hosted application system.

13. The method of claim 11, further comprising in response to receiving from the billing system an authorization to provision service for the potential customer:
transmitting a request to provision service for the potential customer to a second hosted application system.

14. The method of claim 11, further comprising prior to making the one or more offers available to the potential customer at the sign-up system:
determining based upon the expiration date whether the SKU corresponds to an offer that has expired; and
in response to determining that the offer has expired, not making the one or more offers available to the potential customer.

15. The method of claim 11, further comprising prior to making the one or more offers available to the potential customer at the sign-up system:
determining whether the SKU corresponds to an offer that has been invalidated; and
in response to determining that the offer has been invalidated, not making the one or more offers available to the potential customer.

16. The method of claim 12, wherein the hosted application system, sign-up system, marketing system, and billing system are configured to communicate via one or more idempotent application programming interfaces (APIs).

17. The method of claim 13, wherein the second hosted application system comprises a support system.

18. A computer storage medium having computer-executable instructions stored thereon which, when executed by a computer, cause the computer to:
receive a first request via an idempotent application programming interface (API), the first request comprising a request for a product key;
in response to the first request, to generate an encrypted product key comprising a stock-keeping unit (SKU), an expiration date, and a unique identifier;
receive a second request subsequent to the first request via the API, the second request comprising a request to decrypt the product key; and
in response to the second request, to decrypt the product key to extract the SKU, the expiration date, and the unique identifier, to determine based upon the expiration date and the unique identifier whether the SKU corresponds to an offer that should be made available to a potential customer, and returning the SKU in response to the second request in response to determining that the SKU corresponds to an offer that should be made available to the potential customer.

19. The computer storage medium of claim 18, further comprising:
receiving a request via the API to provision service for the potential customer; and
in response to receiving the request, provisioning service for the potential customer.

20. The computer storage medium of claim 19, further comprising:
receiving a request to verify sign-up information for a potential customer;
verifying the sign-up information in response to the request; and
returning an indication as to whether the sign-up information could be verified in response to the request.
